(19) United States
(12) Patent Application Publication
(10) Pub. No.: US 2022/0266441 A1
(43) Pub. Date: Aug. 25, 2022

(54) EXTENSION POLE FOR COATING KNIFE, AND SMOOTHING ASSEMBLY COMPRISING SUCH A POLE

(71) Applicant: ÉTABLISSEMENTS PIERRE GRÉHAL ET CIE SA, BAILLET EN FRANCE (FR)

(72) Inventor: Lionel DELESTRE, Beaumont-sur-Oise (FR)

(21) Appl. No.: 17/568,789

(22) Filed: Jan. 5, 2022

(30) Foreign Application Priority Data
Feb. 22, 2021 (FR) 2101714

(51) Int. Cl. B25G 1/04; B05C 17/00

(52) U.S. Cl. CPC B25G 1/04; B05C 17/00

(57) ABSTRACT

A pole is provided for a coating knife provided with a profiled handgrip that is easy, practical, rapid and safe to use. The pole includes a handle and a first fixing part for fixing to the handgrip of the coating knife and having a contact surface of complementary shape to the profile of the handgrip of the coating knife. The pole also includes a distal part that is near the blade of the coating knife in the position of use. A proximal part is provided arranged opposite the distal part. The first fixing part further includes at least two fixing lugs mounted in a pivoting manner on the proximal part of the first fixing part and conformed to be swung over the distal part of the first fixing part.

The invention relates to an extension pole for a coating knife, to a method of using said pole, and to a smoothing assembly comprising such a pole and a coating knife.

To be more precise, the invention concerns an extension pole for coating knifes of the type having a handgrip constituted by an extrusion arranged in a manner parallel to the edge of the blade. There may be cited by way of example the document FR2913705 or the document FR1911416 that describe such a coating knife.

This type of handgrip has the advantage of enabling the production of the handgrip using an extrusion that can be cut to the required length. It is therefore possible to manufacture coating knifes of great length, which enables faster and more homogeneous work, because the application force is transmitted over all the width of the blade.

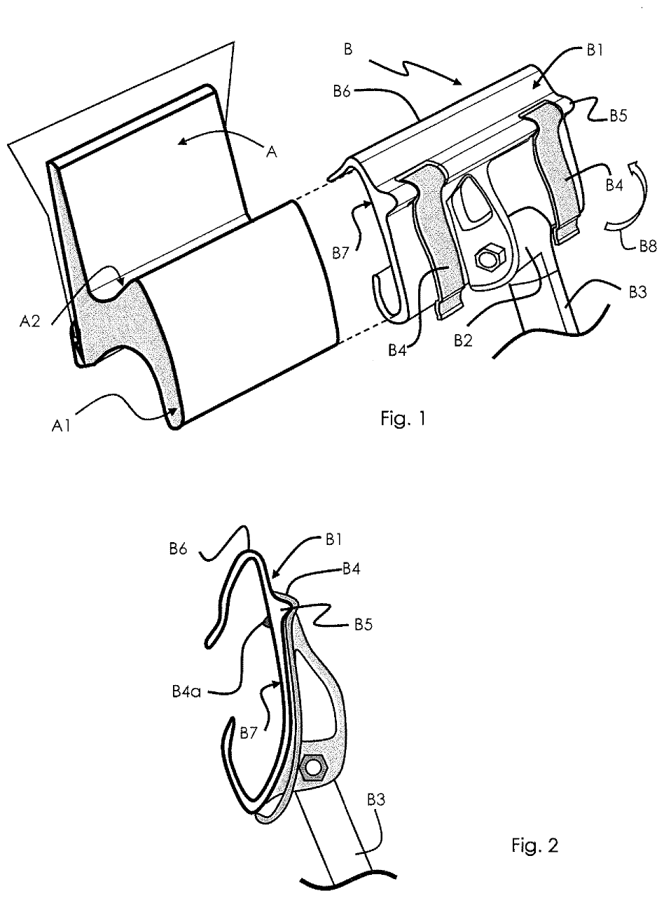

The handgrip A of the coating knife from the document FR2913705, illustrated in FIG. 1, has a lever zone A1 that in use comes to be placed in the hollow of the sum and a gripping zone comprising a curved convex fixing face A2 against which the fingers of the user may be bent.

When the user applies the coating knife against the wall, they therefore apply a high smoothing force with one or both hands, thanks to the lever zone A1. In other words, this lever zone is strongly held by the user because it is subjected to the greatest stress during smoothing.

The document FR2913705 evokes an extension pole comprising a handle and a fixing end of complementary shape to the handgrip A of the coating knife, without so much as describing in detail the structure of that end.

An extension pole B for the coating knife from the document FR2913705 is already on sale and illustrated in FIGS. 1 and 2. This extension has been designed to reproduce the movement of the hand of the user by gripping the back of the handgrip to act as a lever, like the thumb of the user, and by strongly gripping the front gripping zone, like the fingers of the user.

The fixing end B1 has a shape complementary to the profile of the handgrip A of the coating knife. The fixing end B1 also includes a ball-and-socket joint B2 for fixing it to the handle B3 of the pole.

The fixing part B1 also includes two fixing lugs B4 articulated to a reinforcing groove B5 on the distal part situated to the front of the fixing part B1, that is to say toward the edge B6 of the holding portion B1 at the greatest distance from the handle B3. The reinforcing groove B5 is arranged substantially above the gripping zone A2 of the handgrip A of the coating knife when it is fixed to the fixing part B1 and therefore at a distance from the lever zone A1 of said handgrip.

The fixing lugs B4 include a rib B4a (see FIG. 2) forced into contact with the handgrip A of the coating knife. When the coating knife is present, the forced contact ribs are forcibly applied against the handgrip and retain the latter strongly in the fixing part. In contrast, when the coating knife is absent, the rib of each lug B4 projects from the interior surface B7 of the fixing part intended to be in contact with the handgrip of the coating knife, which is illustrated in FIG. 2.

Consequently, to be able to slide the handgrip of the coating knife into the fixing part of the prior art pole it is first necessary to cause the fixing lugs B4 to pivot toward the front of the fixing part, in the direction of the arrow B8, to retract the ribs so that they do not project from the interior surface B7 and do not prevent the handgrip A from sliding into the fixing part B. To prevent these lugs from falling back or to avoid having to hold them with one hand, it is necessary to fit the pole “upside down”, that is to say with the handle at the top and the fixing part placed on the ground. The handgrip of the coating knife is then able to slide, after which the fixing lugs are forcibly swung one by one in the direction opposite the arrow F1 so that their ribs are forcibly applied against the front of the handgrip of the coating knife.

This pole is somewhat impractical because of its position of use. Moreover, the latter obliges manipulation of the coating knife in the immediate vicinity of the ground, which risks damaging it or soiling it. Moreover, the pole is slow to use because it necessitates many manipulations. Finally, when the pole is used with a coating knife of great length, the smoothing of the coating obtained is of less good quality than when the same coating knife is used manually.

An objective of the present invention is therefore to propose a pole that is easy, practical, rapid and safe to use.

Another objective of the present invention is to propose a pole that procures smoothing identical to the smoothing obtained manually with the coating knife alone, in particular with coating knifes of great length, that is to say greater than at least 50 cm long, in particular coating knifes 80 to 100 cm long.

The idea underlying the invention has been to move the location of the fixing lugs by articulating them to the rear of the fixing part, near the fixing ball-and-socket joint of the handle, above the lever zone of the handgrip of the coating knife when the latter slides in the fixing part of the pole and in such a manner as to cap the front of the fixing part when they are in the fixing position. Another idea has been, in a preferred embodiment, to increase the area of contact with the fixing part by joining the two lugs with a gripping tongue conformed to be immobilized on the front part of the fixing part situated over the gripping zone of the handgrip of the coating knife when the latter is inserted therein, which concomitantly makes it much simpler to use.

To be more precise the invention has for object a pole for a coating knife provided with a handgrip constituted by an extrusion, the pole comprising a handle and a member for fixing the handle to a first fixing part of the handgrip of the coating knife, the first fixing part having a contact surface of complementary shape to the profile of the handgrip of the coating knife, a distal part near the blade of the coating knife when the latter is fixed in the first fixing part in the position of use, and a proximal part arranged opposite the distal part, near the handle, the first fixing part further including at least two fixing lugs mounted in a pivoting manner, the fixing lugs being articulated to the proximal part of the first fixing part and conformed to be swung over the distal part of the first fixing part.

The articulation of the fixing lugs to the distal part of the fixing part enables the ribs of the fixing lugs to grip the handgrip of the coating knife by at the level of the lever zone of the handgrip, whilst stiffening the grip at the level of the gripping zone of the handgrip thanks to the part of the fixing lugs that comes to be swung against the distal edge of the fixing part. This arrangement assures easier use whilst enabling better retention of the handgrip than a prior art extension, as well as a smoothing quality identical to that which is obtained manually with the coating knife alone.

According to particular embodiments:
the at least two fixing lugs may include a portion articulated on the first fixing part and a holding portion, the at least two fixing lugs being connected to one another at least by their holding portion;
the at least two fixing lugs may be connected to one another by their holding portion in such a manner as to form a space between their articulation portions sufficient to allow the fixing member of the handle to pass through;
the at least two fixing lugs may be conformed to be locked onto the distal part of the first fixing part;
and/or
the pole may further include a ring mounted to slide along the handle and provided with a reversible locking means, the ring being connected in a pivoting manner to a first end of at least one arm connected by a second end to a second part for fixing to the handgrip of the coating knife.

The invention also has for object a smoothing assembly comprising the above pole and at least one coating knife including a profiled handgrip of complementary shape to the first fixing part of the pole.

Other features of the invention will be set out in the following detailed description with reference to the appended figures, provided by way of example, and which respectively represent:

FIG. 1, a schematic perspective view of a prior art coating knife handgrip being mounted on a prior art extension pole;

FIG. 2, a schematic profile view of the FIG. 1 prior art pole, illustrating the position of the fixing tongue when the pole is in the “right way up” position, that is to say with the handle resting on the ground and the fixing part at the top;

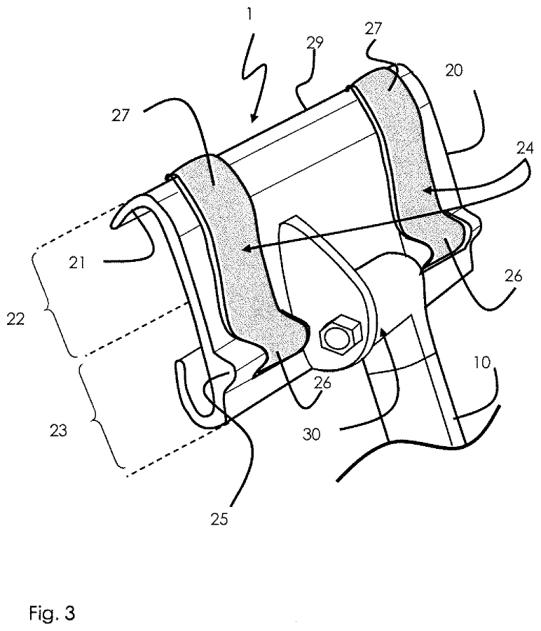

FIG. 3, a schematic perspective view of a first embodiment of a pole according to the invention for a coating knife provided with an extruded handgrip;

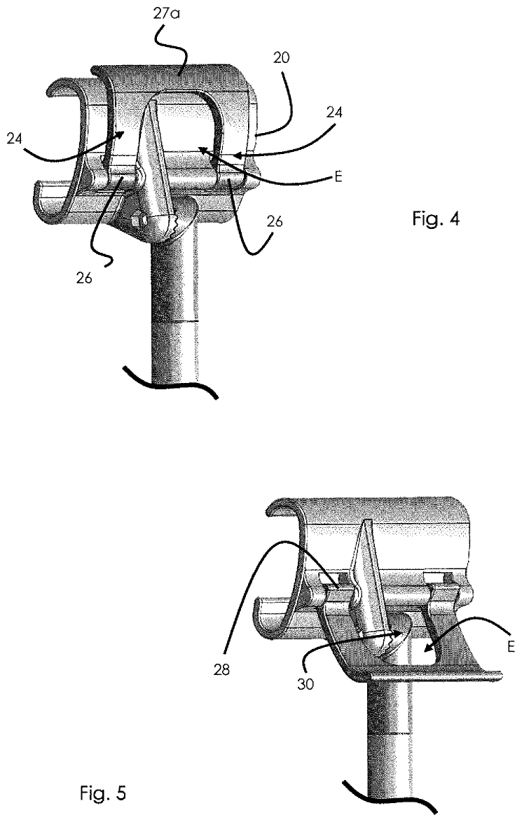

FIG. 4, a schematic perspective view of a second embodiment of a pole according to the invention, in which the two fixing tongues are connected by their holding part so as to form a single component, the fixing tongues being in a locked position;

FIG. 5, a schematic perspective view of the pole from FIG. 4, in which the fixing tongues are in an unlocked position;

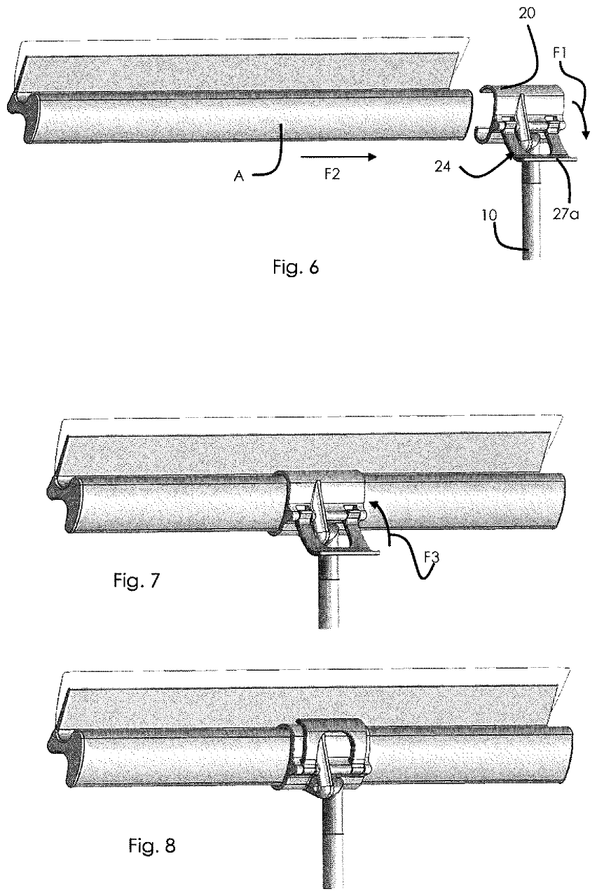

FIG. 6, a schematic perspective view of the pole from FIG. 4, in the unlocked position and pending positioning of a coating knife with a profiled handgrip;

FIG. 7, a schematic perspective view of the pole from FIG. 6, in the unlocked position and positioned on the coating knife with a profiled handgrip;

FIG. 8, a schematic perspective view of the pole from FIG. 7, in the locked position;

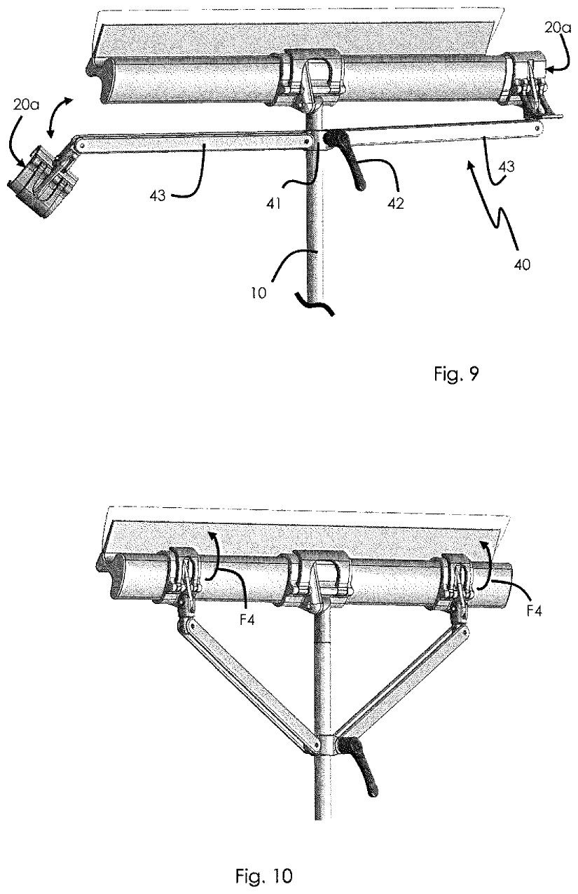

FIG. 9, a schematic perspective view of the pole from FIG. 8, further including a lateral stiffening system being assembled; and

FIG. 10, a schematic perspective view of the pole from FIG. 9, on completion of assembly.

A first embodiment of the pole according to the invention is illustrated in FIG. 3.

In this figure the pole is illustrated “right way up”, that is to say with the handle resting on the ground and the part for fixing the coating knife at the top.

This position is ideal for the user because they can position the coating knife on the pole when standing, the coating knife being far from the ground.

The pole 1 according to the invention therefore includes a handle 10 fixed to a first part 20 for fixing the handgrip of the coating knife by means of a fixing member 30. This fixing member is preferably of the type enabling fixing at an adjustable angle between the handle and the part for fixing the coating knife, such as a ball-and-socket joint for example.

The first fixing part 20 is an extrusion that has a contact surface 21 of complementary shape to the profile of the handgrip of the coating knife so that said handgrip can slide in the first fixing part 20 (see FIGS. 6 to 8).

The first fixing part 20 includes a distal part 22 arranged near the blade of the coating knife in the position of use, that is to say when the coating knife is fixed in the first fixing part 20.

The first fixing part 20 also includes a proximal part 23 arranged opposite the distal part 22 and near the handle 10.

According to the invention, the first fixing part 20 further includes at least two fixing lugs 24 mounted in a pivoting manner on the proximal part 23 of the first fixing part 20 and conformed to be swung over the distal part of the first fixing part. This arrangement enables gripping above the lever zone of the handgrip of the coating knife, which improves to a surprising degree the quality of retention of the coating knife and consequently the quality of smoothing of the coating using a pole.

To be more specific, the first fixing part 20 includes a reinforcing rib 25 arranged transversely along the proximal part 23, the at least two fixing lugs being articulated on this reinforcing rib 25.

The fixing lugs 24 have a portion 26 for articulating them on the first fixing part and a holding portion 27 enabling the user to grasp them to cause them to pivot between an open position for inserting a coating knife and a position of use in which the fixing lugs are pressed forcibly against the handle of the coating knife by means of their clamping rib 28 (see FIG. 5).

Thanks to this arrangement, when the pole is in the “right way up” position, the user can grasp the holding parts and lower them. They will be assisted by gravity, which draws the holding parts downward and thus holds the fixings lugs naturally in the open position, that is to say in a position in which the forcible contact ribs 28 are retracted from the surface 21 in contact with the handgrip of the coating knife. It is therefore very easy for the user to slide the handgrip of the coating knife in the fixing part 20 because the forced contact ribs 28 do not project from the contact surface and the user does not have to hold the fixing lugs open (see FIG. 5).

The holding portion 27 advantageously includes a free end conformed to be immobilized on the distal part 22 of the first fixing part 20, that is to say to be immobilized against the distal edge 29 of the first fixing part at the greatest distance from the handle. This enables anterior and posterior fixing of the first fixing part 20 on the handgrip of the coating knife, that is to say gripping above the front gripping zone of the handgrip of the coating knife, and gripping above the lever zone of the handgrip of the coating knife, further improving the quality of retention of the handgrip and therefore the quality of smoothing.

A second, very interesting embodiment of a pole according to the invention is illustrated in FIG. 4.

In this embodiment the two fixing lugs 24 are connected to one another by their holding portion 27a which is therefore common to the two lugs 24. However, each lug 24 includes its own portion 26 articulated on the first fixing part 20.

It is therefore possible with one gesture to clamp and to unclamp the two fixing lugs 24.

The two fixing lugs 24 are advantageously connected to one another by their holding portion 27a in such a manner as to form a space E between their articulation portions sufficient to allow the fixing member of the handle to pass through. As FIGS. 4 and 5 show, this enables simultaneous closing and opening of the fixing lugs without being impeded by the presence of the fixing member of the handle and of the handle itself.

FIGS. 6 to 8 illustrate a method of using the pole according to the invention. These figures illustrate the second embodiment in which the fixing lugs are fastened to one another by means of their holding portion. However, this process is similar with the first embodiment, with the sole difference being that it will be necessary to deactivate and to activate the fixing lugs sequentially and not simultaneously.

To fix a coating knife A to the pole according to the invention the user places the handle of the pole on the ground so that the first fixing part 20 is directed upward. They then cause the fixing lugs 24 to pivot downward, in the direction of the arrow F1, so that the forced contact ribs 28 are retracted from the surface in contact with the handgrip of the coating knife.

They can then let go of the fixing lugs, which remain in the open position thanks to gravity.

They then grasp the handgrip of the coating knife and offer it up facing the first fixing part 20 (FIG. 6) in such a manner as to be able to slide it in the fixing part 20 in the direction of the arrow F2 as far as the FIG. 7 position.

They then swing the fixing lugs upward in the direction of the arrow F3, here by means of the single holding portion 27a, to forcibly clamp the contact ribs (not visible) against the handgrip of the coating knife, thus arriving at the FIG. 8 position. The holding portion is advantageously conformed to be immobilized against the distal edge of the first fixing part so that additional clamping is obtained.

To dismount the coating knife from the pole, the user again positions the pole “right way up” and then lowers the fixing lugs 24, in the direction of the arrow F1. In addition to gravity, the spring effect of the fixing lugs previously forcibly wedged against the handgrip of the coating knife by means of the ribs 28 will assist the user to position the fixing lugs 24 in the open position.

They can then let go of the fixing lugs, which remain in the open position thanks to gravity.

They then grasp the handgrip of the coating knife and slide it out of the fixing part 20 in the direction opposite the arrow F2 to reach the FIG. 6 position.

At no time does the coating knife risk being soiled or damaged against the ground.

The arrangement of the fixing lugs 24 according to the invention further enables the easy use of a reinforcing system 40 for coating knifes of great length with no risk of damaging the coating knife.

This third embodiment is illustrated in FIGS. 9 and 10.

In this third embodiment the pole further includes a ring 41 mounted to slide along the handle 10 and provided with reversible immobilizing means 42 illustrated by way of example by a quick-clamp handle.

The ring 41 is connected in a pivoting manner to a first end of an arm 43 connected at a second end to a second part 20a for fixing to the handgrip of the coating knife. In the embodiment illustrated, the ring is connected to two arms 43 each having a second part 20a for fixing to the handgrip of the coating knife.

The second fixing part 20a is connected to the second end of the arm in a pivoting manner to enable it to be threaded onto the handgrip of the coating knife.

Use is very simple: to fix the reinforcing system 40 the user positions the pole “right way up” and frees the ring 41, that is to say deactivates the fixing means 42 so that the ring is free to slide along the handle.

The user then grasps the second fixing parts 20a in their hands to position them facing the ends of the handgrip of the coating knife A. The ring is then near the first fixing part 20.

They then cause the second fixing parts 20a to slide toward the first fixing part 20. Concomitantly, the ring 41 slides toward the bottom of the handle 10, away from the first fixing part 20.

They then action the fixing lugs 24 of the second fixing parts 20a by moving them upward in the direction of the arrow F4, as described above.

They can then activate the reversible means 42 for immobilizing the ring 41. Before activating the reversible immobilizing means 42, they advantageously push the ring 41 downward to tension the combination to the maximum.

In an embodiment that is not illustrated the arms 43 can be telescopic.

The use of this reinforcing system is allowed by the particular arrangement of the fixing lugs 24 that allows great freedom of movement and avoids having to hold them to maintain the open position.

The use of the reinforcing system 40 according to the invention enables identical smoothing to be obtained to the smoothing obtained manually using the coating knife on its own, that is to say with no pole, in particular in the case of coating knifes of great length, that is to say coating knifes greater than at least 50 cm long, in particular coating knifes 80 to 100 cm long.

The pole according to the invention may be sold on its own or with at least one coating knife the profiled handgrip of which has a shape complementary to the first fixing part.

It may equally, instead or additionally be sold with a reinforcing system 40 for coating knifes of great length.

1. Pole (1) for a coating knife provided with a profiled handgrip (A), the pole comprising a handle (10) and a member (30) for fixing the handle (10) to a first fixing part (20) of the handgrip (A) of the coating knife, the first fixing part (20) having a contact surface (21) of complementary shape to the profile of the handgrip of the coating knife, a distal part (22) near the blade of the coating knife when the latter is fixed in the first fixing part in the position of use, and a proximal part (23) arranged opposite the distal part (22), near the handle (10), the first fixing part (20) further including at least two fixing lugs (24) mounted in a pivoting manner, characterized in that the fixing lugs (24) are articulated to the proximal part (23) of the first fixing part (20) and conformed to be swung over the distal part (22) of the first fixing part (20).

2. Pole according to claim 1, in which the at least two fixing lugs (24) include a portion (26) articulated on the first fixing part (20) and a holding portion (27a), the at least two fixing lugs (24) being connected to one another at least by their holding portion (27a).

3. Pole according to claim 2, in which the at least two fixing lugs are connected to one another by their holding portion (27a) in such a manner as to form a space (E) between their articulation portions (26) sufficient to allow the fixing member (30) of the handle to pass through.

4. Pole according to claim 1, in which the at least two fixing lugs (24) are conformed to be locked onto the distal part (22) of the first fixing part (20).

5. Pole according to claim 1, further including a ring (41) mounted to slide along the handle (10) and provided with a reversible locking means (42), the rings being connected in a pivoting manner to a first end of at least one arm (43) connected by a second end to a second part (20a) for fixing to the handgrip of the coating knife.

6. Smoothing assembly comprising a pole (1) according to claim 1 and at least one coating knife comprising a profiled handgrip (A) of complementary shape to the first fixing portion (20) of the pole.
